(19) United States
(12) Patent Application Publication
(10) Pub. No.: US 2018/0346737 A1
(43) Pub. Date: Dec. 6, 2018

(54) A MULTI-LAYERED STRUCTURE OF AT LEAST A METAL BASE-LAYER AND A PAINT-BASED PROTECTIVE LAYER OR A PASTE-BASED PROTECTIVE LAYER

(71) Applicant: Beele Engineering B.V., Aalten (NL)

(72) Inventor: Johannes Alfred Beele, Aalten (NL)

(21) Appl. No.: 15/778,211

(22) PCT Filed: Nov. 23, 2016
(86) PCT No.: PCT/EP2016/078532

§ 371 Date: May 22, 2018

(30) Foreign Application Priority Data
Nov. 23, 2015 (NL) 1041592

(51) Int. Cl. C09D 5/18; F16L 57/04; B32B 15/08

(52) U.S. Cl. CPC C09D 5/18; B32B 2597/00; B32B 15/08; F16L 57/04

(57) ABSTRACT

A multi-layered structure of at least a metal base-layer and a paint-based protective layer or a paste-based protective layer, the protective layer being non-intumescent, wherein the protective layer exhibits at atmospheric pressure during an increase in ambient temperature a drop in its thermal conductivity.

### INTRODUCTION

Metal layers are widely present. Metal is known to be a good heat conductor, in that through a metal thermal energy is relatively swiftly conducted from a position having a high temperature to a position having a low temperature. If a metal has a temperature that is higher than the ambient temperature, then metals will pass thermal energy on to the ambience. If all positions of a metal are at an equal temperature and thermal energy is directed towards the metal, the overall temperature of the metal will increase. At a certain elevated temperature, the metal will melt. This applies particularly to aluminium which has a relatively low melt temperature. Constructions of aluminium are in that sense vulnerable.

For certain applications it would be desirable to ensure that a metal will at least at a pre-determined position on the metal not give off too much heat to the ambience, or to an object that is positioned against the metal. An insulating layer put on the metal on those positions may assist in reaching that aim. For certain applications it is of crucial importance that metal is protected from too much heat input as generated, for instance by a nearby fire.

### SUMMARY

The present disclosure provides a multi-layered structure of at least a metal base-layer and a paint-based protective layer or a paste-based protective layer, the protective layer being non-intumescent, wherein the protective layer exhibits at atmospheric pressure during an increase in ambient temperature, a drop in its thermal conductivity.

This protective layer has the advantage that it will start protecting the metal against exposure to higher temperatures, when such exposure starts taking place.

In an embodiment, the protective layer has a porous structure or forms pores at elevated temperatures. Without wishing to be bound by any theory, it is believed that these pores contribute significantly to a drop in the thermal conductivity of the protective layer, particularly at higher temperatures.

In a material having a porous structure, the thermal conductivity is to an extent determined by conduction of heat by gas. The pores provide many transitions from a pore, i.e. a small cavity (in which heat can be conducted by gas) to a material through which no conduction by gas can occur. A heated gas molecule can collide with the surface of the material, and as such pass on some of the thermal energy. However, such a collision will largely be elastic, so that the back-bouncing gas molecule will not have passed on much of its thermal energy to the material. As a consequence of this phenomenon, the thermal energy is effectively kept in the gas. The heat is not efficiently transported through the entire protective layer. This may explain, at least to an extent, the low thermal conductivity of the protective layer. It is believed that also thermal conductivity by means of radiation (more detailed below) is suppressed in a material having pores. The smaller the pores, the smaller the thermal conductivity by radiation, is presently believed.

A number of different ways of forming a porous structure at elevated temperatures will be mentioned below. A way of forming pores at elevated temperatures could occur by evaporation of liquids out of the protective layer at elevated temperatures, leaving at these higher temperatures empty pores, or cavities, behind. It will also be possible to form pores by spraying material forming the paint-based protective layer onto the metal base-layer. Further, as discussed below, the type of material and size of its particles may be such that pores are formed.

In an embodiment, the pores comprise pores having a diameter of less than 700 nanometers. Again, without wishing to be bound by any theory, it is believed that such small pores contribute very significantly to a drop in thermal conductivity of the protective layer, when the ambient temperature rises, for instance, due to a nearby fire. First of all, many small pores would also mean many transitions between a cavity and a material. The heat will predominantly remain within the gas as the transitions do not provide smooth transfers of heat from the gas to the material and vice versa. The transport of the thermal energy will be frustrated.

Preferably the pores comprise pores having a diameter of less than 70 nanometers. Where the main mechanism for transport of thermal energy is based on conduction of heat by gas, the transport mechanism can also be described as inelastic collisions of a gas molecule having a lot of thermal energy with a gas molecule having less thermal energy. It is thus the number of these collisions that determines to an extent the thermal conductivity of heat through a gas. A parameter related to the number of collisions is the so-called mean-free path of a gas molecule. This is defined as the average distance traveled by a moving gas molecule between successive collisions. The length of this mean-free path is known to increase with the temperature of the gas. If the mean-free path of the gas is longer than the diameter of the cavity in which the heated gas molecule is present, then the gas molecule is more likely to first hit the surface of the material that forms the boundary of the cavity, than with another gas molecule. As explained above, the gas molecule may on colliding with a material pass on some of its thermal energy, but the majority will remain with the gas molecule. For many gas molecules, particularly air molecules (oxygen molecules and nitrogen molecules) the mean-free path at elevated temperatures is higher than 70 nanometers. Collisions between gas molecules are then thus rare. A heated gas molecule has very little chance to pass on energy to another gas molecule. Conduction of heat through the gas phase is now thus even further frustrated. Accordingly, it is believed that heat cannot be swiftly transported through a material comprising many pores having a diameter of less than 70 nanometers, if the predominant mechanism for transport of heat is based on gas conduction.

In an embodiment the protective layer comprises clusterings of particles having a size within the range of 2-300 nanometers.

So far consideration is mainly given to heat conduction by gas. However, heat can also be transported through materials. Thus the bit of heat energy passed on to a material during a collision of a gas molecule with that material, could possibly “travel” down a temperature gradient in that material. Two mechanisms are known. One mechanism is based on electrons which pass on thermal energy. This is why metals, considered to have many so-called free electrons, are good heat conductors. Another mechanism is based on atoms which pass on thermal energy. It turns out that the more rigid the atomic structure is, and the more pure the structure is, the more likely it is that this mechanism for transport of heat works really well. In support of this view, it is to be noted that a single crystal diamond is one of the best heat conductors (having a very rigid and often pure atomic structure), even though it is electrically insulating (that is, no of the electrons are available for transport of heat through the material.

Advantageously, such a structure comprising clusterings of particles having a size within the range of 2-300 nanometers, has more likely many pores and thus the characteristics described above.

Further, such a structure leads to a material having many impurities in the sense that each boundary of a particle, particularly when placed against the boundary of another particle, forms an irregularity in the structure of the particle.

Furthermore, due to the many pores, the material is also not dense, and not rigid. The result is that heat cannot efficiently be passed on from the structure of one particle to the structure of another particle. This does inherently lead to a low thermal conductivity of that material itself, i.e. regardless of the low thermal conductivity of gas in pores that may be present in such a material.

Furthermore, the presence of clusterings of nanoparticles, not only introduces irregularities, there are also “bottlenecks” formed where the particles join. It is believed that such necking between nanometer-sized particles introduces a problem for the heat to be passed on through the materials, based on, effectively, phonon-transport. Such a resistance contributes to a further drop in thermal conductivity of that material itself, i.e. regardless of the low thermal conductivity of gas in pores that may be present in such a material. This contributes to the low thermal conductivity of the protective layer.

In an embodiment, pores are formed at temperatures in the range of 180-500° C. This means that a drop in thermal conductivity, caused by formation of pores, is well before a temperature at which most metal start melting. Notably, aluminum has a melting point at around 600° C. A further advantage is that the substance out of which the protective layer is formed, can before application of that substance onto the metal base-layer be in a liquid or viscous condition, so as to allow for application of the substance onto the metal base-layer by spraying, or spreading with a knife or so. For spraying, the substance needs to be in a liquid form as the material needs to be flowable to a nozzle out of which it will be sprayed. The liquid form also allows for introduction of air into the spray so as to also produce a porous material on settling of the sprayed particles in layer form onto the metal base-layer. Including air during spraying may result in air entrapped in cavities in the protective layer. Also when the protective layer is a paste-based protective layer and spread onto the metal base-layer by a dedicated tool, it needs and can be in a relatively viscous state. The temperature is during application of the paste so as to form a protective layer, unlikely to reach a lower end of the range of temperatures in which the pores are formed. Only at higher temperatures, for instance such as generated by a nearby fire, the need for a drop in thermal conductivity is at least partly addressed by formation of the pores.

In an embodiment the protective layer comprises opacities for reducing heat transfer by radiation.

Heat transfer by radiation, often referred to as thermal radiation, is electromagnetic radiation generated by the thermal motion of charged particles in matter. The surface of a heated material may emit such radiation through its surface. This is typically Infrared radiation. The rate of heat transfer by radiation is dependent on the temperature of a surface. With an increasing temperature, the heat transfer by radiation increases rapidly. Opacifiers in a material counteract that mechanism, for instance by scattering the radiation, or by absorbing the radiation. An example of an opacifier that scatters radiation is titanium dioxide. An example of an opacifier that absorbs radiation is carbon soot. Transparency of the material tends to become lower when opacifiers are used.

It is further believed that thermal conductivity by means of radiation is suppressed in a material that contains pores. The smaller the pore, the smaller the transfer of thermal energy by radiation.

In an embodiment, the multi-layered structure is preferably free from a primer layer between the metal base-layer and a protective layer. This facilitates low costs and no need for labour intensive application.

The protective layer is preferably a fire-retardant layer so that when a fire reaches the layer, it will exhibit low flame-spreading characteristics and exhibit “no-combustion” characteristics. It will sustain in a fire for a significant amount of time.

Preferably the fire-retardant layer is non-combustible in a fire reaching a temperature of up to 1100° C.

Preferably, the protective layer is within the temperature range of 50-1100° C. effectively free from shrinkage. This ensures that the protective layer does not generate cracks and tears and it will thus maintain a continuous layer carrying out its protective function.

Preferably the protective layer is within the temperature range of 50-1100° C. effectively free from thermal expansions. Advantageously, original dimensions can be maintained and no allowances need to be made for expansion upon exposure to heat.

In an embodiment, a protective layer has a metal side and an ambience side, wherein the protective layer is impermeable to gas when a pressure difference of 30 mBar is set between the metal side and the ambience side. Thus the multi-layered structure is effectively gastight.

In an embodiment, the protective layer is impermeable to water. Once the protective layer is applied, there is no chance for corrosion underneath the insulation.

In an embodiment, the protective layer is salt water resistant. This allows for application of the multi-layered structure in relatively salty environments, such as coastal areas or on the seas/oceans. However, also chemical and/or petrochemical industrial environments may benefit from a protective layer that is salt water resistant.

In an embodiment, the metal base-layer comprises steel. Thus, bridges, ships, oil platforms, pipe of steel, etc. can all be provided with a multi-layered structure according to the present disclosure.

In an embodiment, the metal base-layer comprises aluminum or an alloy thereof. Thus, a ship made of aluminum, can very well be protected against heat impact. The drop in thermal conductivity “kicks in” well before the aluminum becomes weak and/or starts melting.

In an embodiment, the metal base-layer forms at least a part of a pipe.

In an embodiment, the metal base-layer forms at least a part of a conduit for cables and/or pipes.

In an embodiment, the metal base-layer forms at least a part of a ship, an oil platform, or an engineered construction for use on the seas.

In another embodiment, the metal base-layer forms at least a part of a chemical or petrochemical factory.

In a further embodiment, the metal base-layer forms at least a part of an oil storage tank.

The protective layer may be a layer that is formed by using a water-based polymer emulsion.

The invention also relates to a paint- or a paste-base formed using a water-based polymer emulsion, suitable for forming a protective layer for forming a multi-layered structure according to any of the embodiments covered by the present disclosure.

The disclosure is further explained on the basis of a drawing, in which:

FIG. 1 shows in cross-section the first embodiment of a multi-layered structure according to the present disclosure;

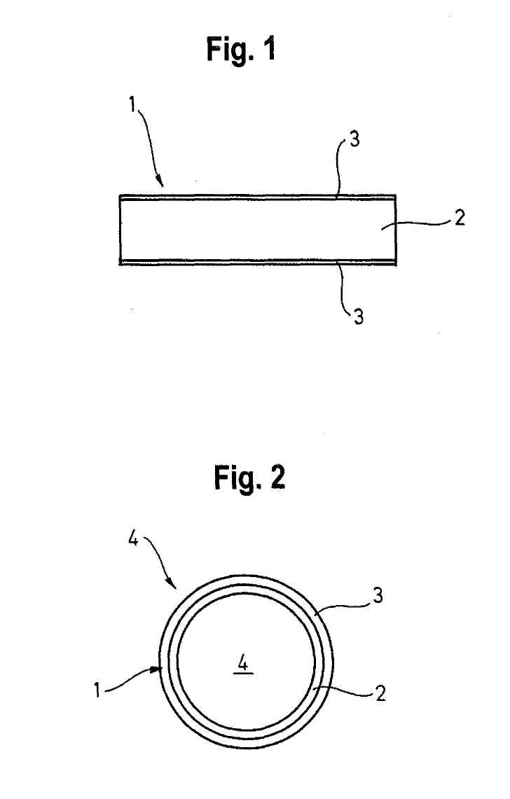

FIG. 2 shows schematically in cross-section a second embodiment of a multi-layered structure according to the present disclosure;

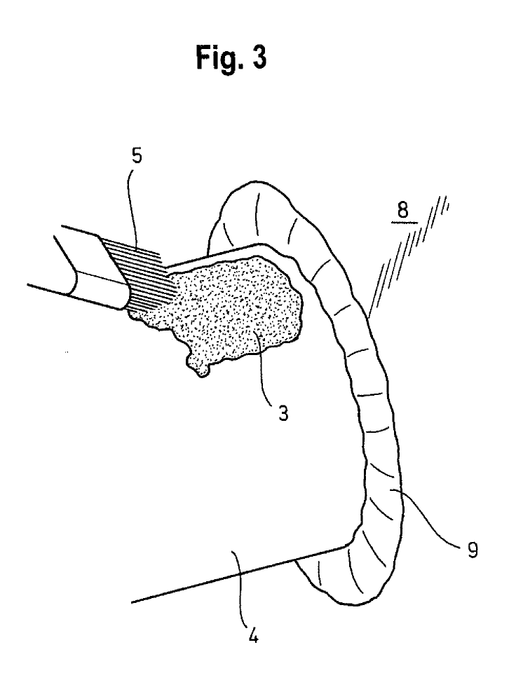

FIG. 3 shows a step in a method of making a multi-layered structure according to the present disclosure;

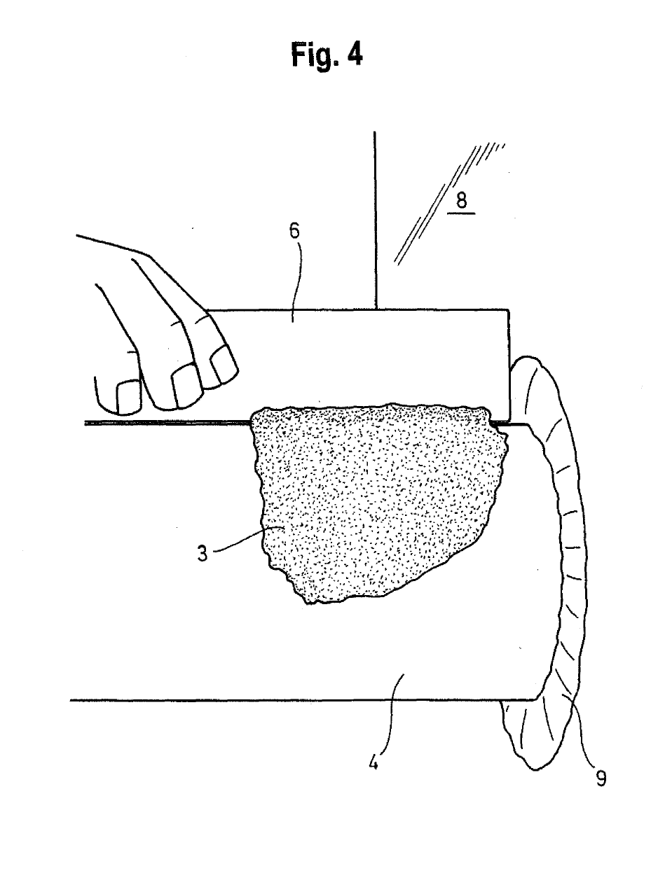

FIG. 4 shows a step in a method of making a multi-layered structure according to the present disclosure;

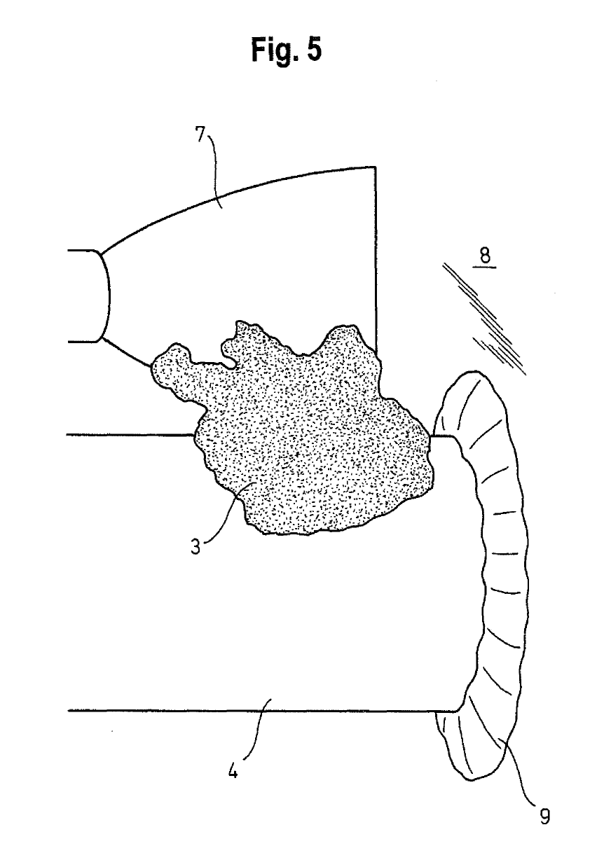

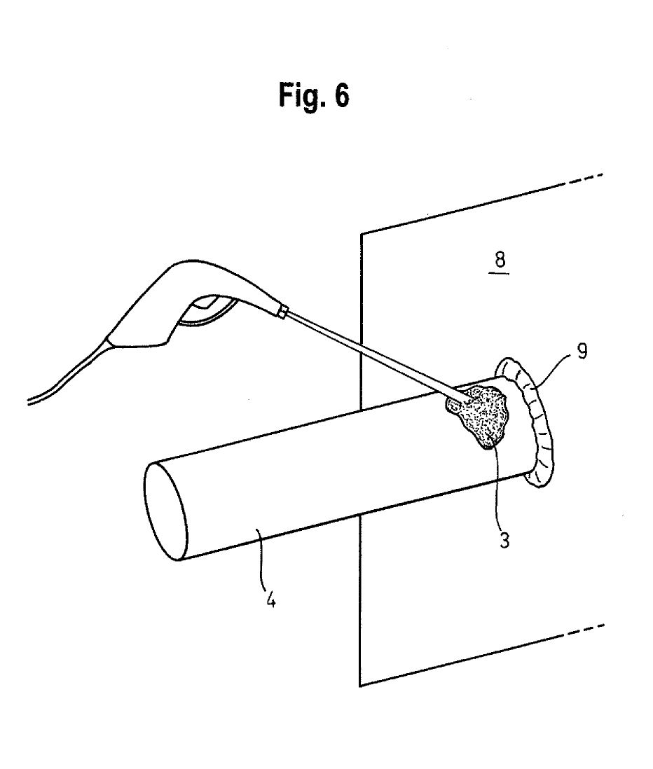

FIG. 5 shows a step in a method of making a multi-layered structure according to the present disclosure; and

FIG. 6 shows a step in an alternative way of a method for making a multi-layered structure in accordance with the present disclosure.

In the description of the drawing, like parts are provided with like references.

FIG. 1 shows in cross-section a multi-layered structure 1 of a metal base-layer 2 and a paint-based protective layer 3. Instead of the paint-based protective layer 3, a paste-based protective layer 3 may be applied. The protective layer 3 is non-intumescent, i.e. it does on exposure to heat not puff up to produce a foam. The protective layer 3 exhibits at atmospheric pressure during an increase in the ambient temperature, a drop in its thermal conductivity. The ambient temperature is the air temperature of the environment in which the protective layer is kept.

FIG. 2 shows in cross-section a pipe 4 having a multi-layered structure 1 according to the embodiment of the present disclosure.

The protective layer 3 may be based on paint. Alternatively, the protective layer 3 is based on a paste.

FIGS. 3, 4 and 5 show the application of the protective layer based on a paste. In FIG. 3 a brush 5 is used. In FIG. 4 a squeegee 6 is used. In FIG. 5 a putty knife 7 is used. The application shown is on a pipe 4 as extending out of a conduit (not shown) in a wall 8. A sealant 9 is applied to seal the annular gap between the pipe 4 and the conduit. However, a person skilled in the art can easily envisage how the application similarly would be applicable onto a flat base-layer.

FIG. 6 shows the application of the base-layer on the basis of a paint, in this example by means of spraying.

The thickness of the layer can be as desired. Spraying for longer, or spraying more layers, will result in a thicker protective layer. The density of the protective layer can be varied, throughout the layer, or held constant per layer. The density can be varied, depending on the number and density of pores.

The protective layer 3 is non-intumescent, meaning that it does not puff up to form a foam when the temperature of the layer increases. The protective layer 3 can be provided by applying a waterbased polymer emulsion, such as the so-called “FISSIC coating”, as commercially available from the applicant (www.fissiccoating.com), in paint form and in paste form.

The protective layer 3 has a porous structure and/or forms pores at elevated temperatures. A porous structure may be present in the particles which at least partly make up the protective layer but may also be formed at elevated temperatures, for instance by release of bonded water out of the protective layer. Pores may also have been formed by the way the protective layer is applied, i.e. by entrapping air into the layer during spraying of the water-based polymer emulsion onto the base-layer 2. The pores may comprise pores having diameters of less than 700 nanometers. Preferably the pores comprise also pores having a diameter of less than 70 nanometers. The pore structure may comprise clusterings of particles having a size within the range of 2-300 nanometers. It is preferable that a number of the pores are formed at temperatures in the range of 180-500° C.

The protective layer may comprise opacities for reducing heat transfer by radiation. Opacities are known in the art, a typical example is titanium dioxide. Another typical example is carbon soot.

The protective layer 3 is preferably a fire-retardant layer. To this end, highly suitably, borates conventionally used as fire retardants; plasticizers of the organic phosphate type such as trialkyl phosphates and triaryl phosphates, and in particular trioctylphosphate, triphenylphosphate and diphenyl cresyl phosphate; solid fire retardants such as ammonium polyphosphate, for instance Antiblaze MC®: and melamine polyphosphate (melapur 200) can be used. These and more fire retardants are well known in the art.

The fire retardant layer is preferably non-combustible in a fire reaching a temperature up to 1100° C. The protective layer 3 is within a temperature range of 50-1100° C. effectively free from shrinkage and, preferably, free from thermal expansion.

The protective layer 3 is salt water resistant, preferably even after fire. Reference is made to KIWA Netherlands report 20150421 HN/01 for the performance of the so-called “FISSIC coating” in this respect. The protective layer 3 is impermeable to water and/or impermeable to gas (at least when the gas pressure difference is 30 mBar. The protective layer prevents corrosion under isolation (CIU) from taking place.

A sprayable emulsion suitable for forming by spraying a protective layer according to the present disclosure is on the day of this disclosure available, at least via the website www.fissiccoating.com. The emulsion is available in paint form as well as in paste form.

Remarkably, when of two identical aluminium pipe parts, one provided with an outer protective layer (according to this disclosure) of 10 mm thickness, and both were equally heated up by a flame directly onto the cylinder wall of the protective layer of one pipe and on the aluminium cylinder wall of the other pipe, the aluminium pipe part that had the protective coating did not swiftly melt away, whilst the other one did. In fact, the unprotected pipe had after 10 minutes fully melted away (and had caused a more intense fire next to the protected pipe). The protected pipe reached a temperature of only 360° C. after 30 minutes and did thus not melt away.

Many applications, each making use of embodiments of the present disclosure, are easily conceivable. Not only in a maritime climate/environment but also in the chemical and petrochemical industry, and in the building industry, use can be made of embodiments of this disclosure.

1. A multi-layered structure of at least a metal base-layer and a paint-based protective layer or a paste-based protective layer, the protective layer being non-intumescent, wherein the protective layer exhibits at atmospheric pressure during an increase in ambient temperature a drop in its thermal conductivity.

2. A multi-layered structure according to any one of the previous claims, wherein the protective layer has a porous structure or forms pores at elevated temperatures.

3. A multi-layered structure according to any one of the previous claims, wherein the pores comprise pores having a diameter of less than 700 nanometers, and preferably less than 70 nanometers.

4. A multi-layered structure according to any one of the previous claims, wherein the porous structure comprises clusterings of particles having a size within a range of 2 to 300 nanometers.

5. A multi-layered structure according to claim 4, wherein pores are formed at temperatures in the range of 180° C. to 500° C.

6. A multi-layered structure according to any one of the previous claims, wherein the protective layer comprises opacities for reducing heat transfer by radiation.

7. A multi-layered structure according to any one of the previous claims, being free from a primer layer between the metal base-layer and the protective layer.

8. A multi-layered structure according to claim 7, being free from any other layer between the metal base-layer and the protective layer.

9. A multi-layered structure according to any one of the previous claims, wherein the protective layer is a fire retardant layer.

10. A multi-layered structure according to claim 9, wherein the fire retardant layer is non-combustible in a fire reaching a temperature up to 1100° C.

11. A multi-layered structure according to anyone of the previous claims, wherein the protective layer is within a temperature range of 50-1100° C. effectively free from shrinkage.

12. A multi-layered structure according to any one of the previous claims, wherein the protective layer is within a temperature range of 50-1100° C. effectively free from thermal expansion.

13. A multi-layered structure according to any one of the previous claims, wherein the protective layer is a layer that is formed using a water-based polymer emulsion.

14. A multi-layered structure according to anyone of the previous claims, wherein the protective layer is salt water resistant.

15. A multi-layered structure according to any one of the previous claims, wherein the protective layer has a metal side and an ambience side, wherein the protective layer is impermeable to gas when a pressure difference of 30 mBar is set between the metal side and the ambience side.

16. A multi-layered structure according to any one of the previous claims, wherein the protective layer is impermeable to water.

17. A multi-layered structure according to any one of the previous claims, wherein the metal base-layer comprises steel.

18. A multi-layered structure according to any one of the previous claims, wherein the metal base-layer comprises aluminium or an alloy thereof.

19. A multi-layered structure according to any one of the previous claims, wherein the metal base-layer forms at least a part of a pipe.

20. A multi-layered structure according to any one of the previous claims, wherein the metal base-layer forms at least a part of a conduit for cables and/or pipes.

21. A multi-layered structure according to any one of the previous claims, wherein the base-layer forms at least a part of ship, an oil platform, or an engineered construction for use on the sea.

22. A multi-layered structure according to any one of the previous claims, wherein the base-layer forms at least a part of a chemical or petrochemical factory.

23. A multi-layered structure according to any one of the previous claims, wherein the base-layer forms at least a part of an oil storage tank.

24. A paint or paste formed using a water-based polymer emulsion, suitable for forming a protective layer for forming a multi-layered structure according to any one of claims 1-23.
